(19) United States
(12) Patent Application Publication
(10) Pub. No.: US 2007/0250323 A1
(43) Pub. Date: Oct. 25, 2007

(54) Apparatus and Method for Encoding and Decoding Plurality of Digital Data Sets

(76) Inventors: Ivan Dimkovic, Berlin (DE); Arno Hornberger, Graben-Neudorf (DE)

Correspondence Address: GLENN PATENT GROUP, 3475 EDISON WAY, SUITE L, MENLO PARK, CA, 94025, US

(21) Appl. No.: 11/460,900

(22) Filed: Jul. 28, 2006

Related U.S. Application Data
(60) Provisional application No. 60/745,350, filed on Apr. 21, 2006.

(51) Int. Cl. G10L 19/00

(52) U.S. Cl. 704/500

(57) ABSTRACT

Method and apparatus for encoding and decoding a plurality of digital data sets, a digital data set having a data frame structure, in which a data frame corresponds to a time period, the number of bits per time period being variable, the plurality of digital data sets being ordered in a time sequence, comprising a means for aggregating the plurality of digital data sets in a content packet and a means for aggregating sequence information on the time sequence in an additional packet, the sequence information being such that a rendering relation of two digital data sets can be derived from the sequence information.

### FIELD OF THE INVENTION

The present invention relates to the field of encoding and decoding digital data, especially video and audio data, and to data storage and transmission.

### BACKGROUND OF THE INVENTION

Traditional modern state-of-the-art audio and video coding and transmission systems, such as for example ISO or MPEG-4 (ISO=International Standardization Organization, MPEG Moving Pictures Expert Group) usually employ means of compression, for example audio compression such as MPEG-4 AAC (AAC=Advanced Audio Coding) and also means of data storage in a broadcast stream, such as ISO 14496-1, MPEG-4 systems.

However, these state of the art systems lack the abilities to completely and truly) offer capabilities of the traditional audio and video storing systems, such as for example audio CD (CD=Compact Disc) respectively CDDA (CDDA=Compact Disc Digital Audio).

Due to the nature of the transform-based audio coding algorithms employed in such solutions, for example psychoacoustic coding, algorithmic delays and codec frame boundary round-offs occur in a decoded stream, which introduces time mismatches between the original and a decoded signal. FIG. 7 illustrates this phenomenon. FIG. 7 shows a digital data set (DDS), which could for example correspond to an encoded audio track, which originally started at a time T_{DDS}. As this digital data set is passed to a decoder, a decoding delay ΔT_{Dec} occurs in the decoded version, for example a decoded audio track will have a delayed playback. This could result in audible gaps if, for example the audio CD tracks are to be played continuously and they are containing continual audio material in the original CD, such as, for example life recording. Generally, a situation as depicted in FIG. 8 may occur. FIG. 8 shows a time axis and four digital data sets DDS1-4. Considering DDS1 and DDS2 FIG. 8 shows that they could potentially overlap, for example they could refer to an audio track and a video track overlapping each other. DDS2 also overlaps DDS3 and DDS4. Furthermore, FIG. 8 shows that there is a gap between DDS1 and DDS3. However, there is no gap between DDS3 and DDS4. DDS3 and DDS4 refer to the example mentioned before, where, if they were referred to for example audio tracks, they are played-out continually in the original, however, if they get encoded into separate encoded audio tracks, a play-out gap occurs due to the coding delay between DDS3 and DDS4, as explained before in FIG. 7.

Furthermore, these coding systems are usually not capable of storing additional timing information about specific events in for example an audio or video signal, while this is possible for example with an audio CD or a DVD by employing index maps. For example, an index map could mark the end of the applause and the life recording and identify the actual music start. Referring to FIG. 8 again, an index map could contain the starting points T_{DDS1-4} as well as mutual timing information. The digital data sets depicted in FIG. 8 could correspond to a video track, for example DDS2, which is underlaid by several audio tracks DDS1, DDS3 and DDS4. If these digital data sets get encoded separately, the individual and mutual timing information gets lost. The coding systems are usually not capable of storing multiple audio programs in the structure similar to for example an audio CD or a video DVD, which in case of audio CDs have multiple audio tracks in a single continual PCM stream (PCM=Puls Code Modulation).

Moreover, these coding systems cannot carry additional value added information, which is present in an additional physical medium, such as album artwork in image form, lyrics, additional information about the author, etc. Additionally, these systems do not employ means for automatic gain compensation so that the listeners' ears would be protected when multiple audio tracks are mastered with different average and maximum loudness levels. Similar drawbacks occur with, for example audio track individual equalization settings or playback settings.

It is therefore the objective of the present invention to provide an apparatus and a method for encoding and decoding a plurality of digital data sets, in order to maintain individual and mutual timing information in an effective way.

### SUMMARY OF THE INVENTION

The objective is achieved by a method and an apparatus for encoding a plurality of digital data sets, a digital data set having a data framed structure, in which a data frame corresponds to a time period, the number of bits per time period being variable, the plurality of digital data sets being ordered in a time sequence, the apparatus comprising a means for aggregating the plurality of digital data sets in a content packet. The apparatus further comprises a means for aggregating sequence information on the time sequence in an additional packet, the sequence information being such that the rendering relation of two digital data sets can be derived from the sequence info.

The objective is further achieved by a method and an apparatus for decoding a plurality of digital data sets, a digital data set having a data frame structure, in which a data frame corresponds to a time period, the number of bits per time period being variable, the decoded plurality of digital data sets being ordered in a time sequence, from a content packet and an additional packet, the content packet comprising the plurality of digital data sets, the additional packet having sequence information on the time sequence, the sequence information being such that a rendering relation of two digital data sets can be derived from the sequence information the apparatus for decoding comprising a means for reading a content packet and the additional packet, and further comprises a controller for extracting the plurality of digital data sets from the content packet, for extracting the sequence information from the additional packet, and for ordering the digital data sets based on the sequence information.

Moreover, the objective is achieved by a data file comprising a content packet and an additional packet, the content packet having information on a plurality of digital data sets, a digital data set having a data frame structure, in which a data frame corresponds to a time period, the number of bits per time period being variable. The additional packet having sequence information on a time sequence of the plurality of digital data sets, the sequence information having information on a rendering relation of two digital data sets.

The present invention is based on the finding that even lossy encoded digital content can be stored continually in a data packet, comprising a plurality of digital data sets, it the timing information containing individual timing information as well mutual timing information between different digital data sets is also stored in a sequence information or an additional packet, the original timing relations can be kept. Using the timing information stored in the additional packet together with the information about the encoded data sets, allows to store and transmit digital data sets with their original timing. The methods and apparatuses solve these problems in a way that there is no dependency on any underlying audio or video compression algorithm, as they refer to a separate process. One embodiment of the present invention perfectly matches the features of the physical CD medium, e.g. continual tracks, additional index maps, bitmap artwork and meta-data such as lyrics, booklets, labels, etc. Aside from providing the full information and meta-data with the audio tracks of a CD, optional compression can be employed, so the digital data sets of the CD can be stored utilizing much less space and in the all-digital form. Embodiments of the present invention also provide additional features, such as storage of loudness information, equalization settings in order to achieve a better protection for the listeners' ears and auditory system.

### BRIEF DESCRIPTION OF FIGURES

Embodiments of the present invention will be detailed using the Figs. attached, in which

FIG. 1 shows a block diagram of an embodiment of an apparatus for encoding;

FIG. 2 shows a block diagram of an embodiment of an apparatus for decoding;

FIG. 3 shows a block diagram of another embodiment of an apparatus for decoding;

FIG. 4 depicts an embodiment of an inventive method for decoding;

FIG. 5 shows another embodiment of an apparatus for decoding;

FIG. 6 shows two embodiments of inventive data packets for storage or transmission;

FIG. 7 illustrates the state of the art decoding a delay; and

FIG. 8 shows an exemplary set of digital data sets.

### DETAILED DESCRIPTION OF THE INVENTION

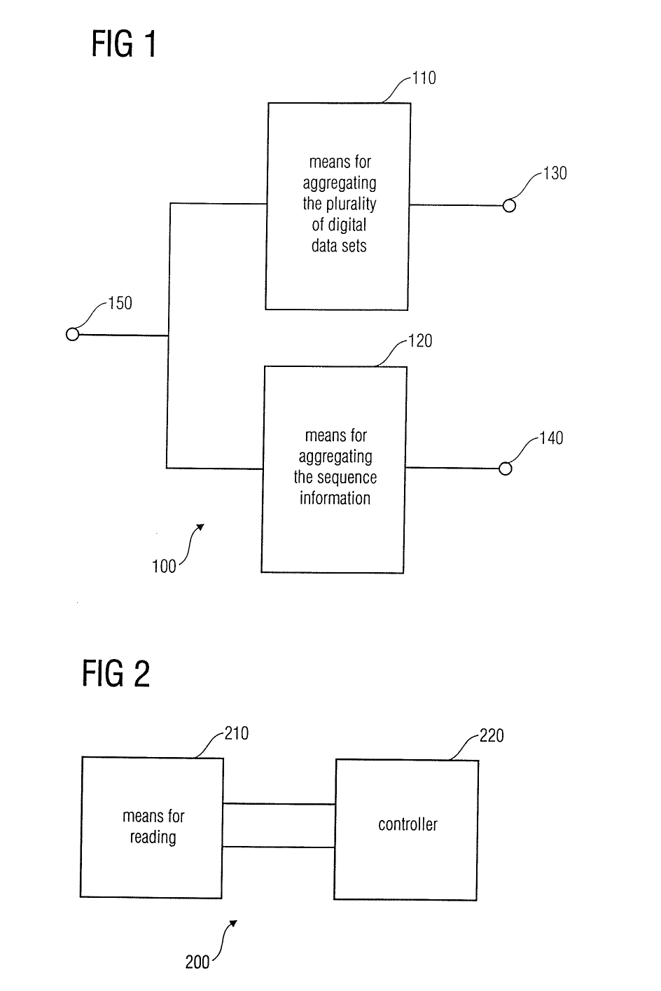

An embodiment of an apparatus 100 for encoding a plurality of digital data sets is depicted in FIG. 1. FIG. 1 shows a block diagram of an embodiment of an apparatus 100 for decoding, comprising a means 110 for aggregating the plurality of digital data sets and a means 120 for aggregating the sequence information. The means 110 for aggregating the plurality of digital data sets has an output 130 for a content packet. The means 120 for aggregating the sequence information has an output 140 for an additional packet. The means 110 for aggregating the plurality of digital data sets and the means 120 for aggregating the sequence information are interconnected and have an input 150 for a plurality of digital data sets, a digital data set having a data frame structure, in which a data frame corresponds to a time period, the number of bits per time period being variable and the plurality of digital data sets being ordered in a time sequence. In one embodiment of the present A invention, the input 150 corresponds to the content of an audio CD. From the original content of the audio CD provided through input 150, the means 110 for aggregating the plurality of digital data sets generates a content file at its output 130, containing the particular tracks of the audio CD, however, utilizing a compression format, for example AAC or MP3. By providing compressed data, which may be psycho-acoustically compressed, a potential decoding delay will be introduced once the plurality of digital data sets is decoded and played-back. Therefore, the means 120 for aggregating the sequence information stores the original sequence information from e.g. an audio CD. In one embodiment of the present invention this corresponds to the starting points of several tracks. In another embodiment, the durations and times of pauses or gaps between the tracks on the original CODs are stored or provided ontop of the starting points. The means 120 for aggregating the sequence information provides an additional packet at its output 140 containing the sequence information. The sequence information allow for derivation of a rendering relation of two digital data sets. The block diagram of the embodiment depicted in FIG. 1 shows the means 110 for aggregating the plurality of digital data sets and the means 120 for aggregating the sequence information being connected through their input 150. In another embodiment of the present invention, the input of an original plurality of digital data sets is not common between the means 110 for aggregating the plurality of digital data sets and the means 120 for aggregating the sequence information but they could be interconnected, anyone of them having an input for the original plurality of digital data sets.

Other information may be provided by the means 120 for aggregating the sequence information with the sequence information is information on a coding type, a coding rate, a coding delay, or a code itself. Embodiments of the present invention include all kinds of digital data sets as, for example, audio data, video data, any kind of meta-data as office documents, etc. in the content packet.

Another embodiment of the present invention the means 120 for aggregating the sequence information includes information on addresses or on logical pointers to the starting points of the digital data sets within the content packet in the sequence information. In yet another embodiment further information on time stamps, timing information, or timing offsets of starting points could be included by the means 120 for aggregating the sequence information. In another embodiment of the present invention, the means 120 for aggregating the sequence information additionally includes meta-data into the additional packet or respectively generates a meta-data packet comprising information on for example one of or a combination of the group of a loudness, an equalization setting, a display setting, playback options of digital data sets or any other meta-data. In another embodiment of the present invention, the apparatus 100 for encoding the plurality of digital data sets further comprises a means for aggregating a meta-data packet.

Additional information that can be provided by other embodiments of the present invention further comprises information on meta-data, instrumentation, lyrics, title, name, song, clip information, place of origin, author, group, singer, interpreter, location of recording, genre, booklets, labels, covers, etc.

FIG. 2 shows a block diagram of an embodiment of the inventive apparatus for decoding the plurality of digital data sets. FIG. 2 shows an embodiment of the apparatus 200 for decoding the plurality of digital data sets, a digital data set having a data frame structure, in which a data frame corresponds to a time period, the number at bits per time period being variable, the decoded plurality of digital data sets being ordered in a time sequence, from a content packet and an additional packet. The content packet comprising the plurality of digital data sets, the additional packet having sequence information on the time sequence, the sequence information being such that a rendering relation of two digital data sets can be derived from the sequence information. The apparatus 200 for decoding comprises a means 210 for reading the content packet and the additional packet. The apparatus 200 for decoding further comprises a controller 220 for extracting the plurality of digital data sets from the content packet, for extracting the sequence information from the additional packet, and for ordering the digital data sets based on the sequence information. The means 210 for reading the content packet and the additional packet is coupled with the controller in order to provide the content packet and the additional packet. In FIG. 2 this is illustrated by the two connections between the means 210 for reading and the controller 220. Embodiments of the present invention may have only a single physical coupling between the means 210 for reading and the controller 220.

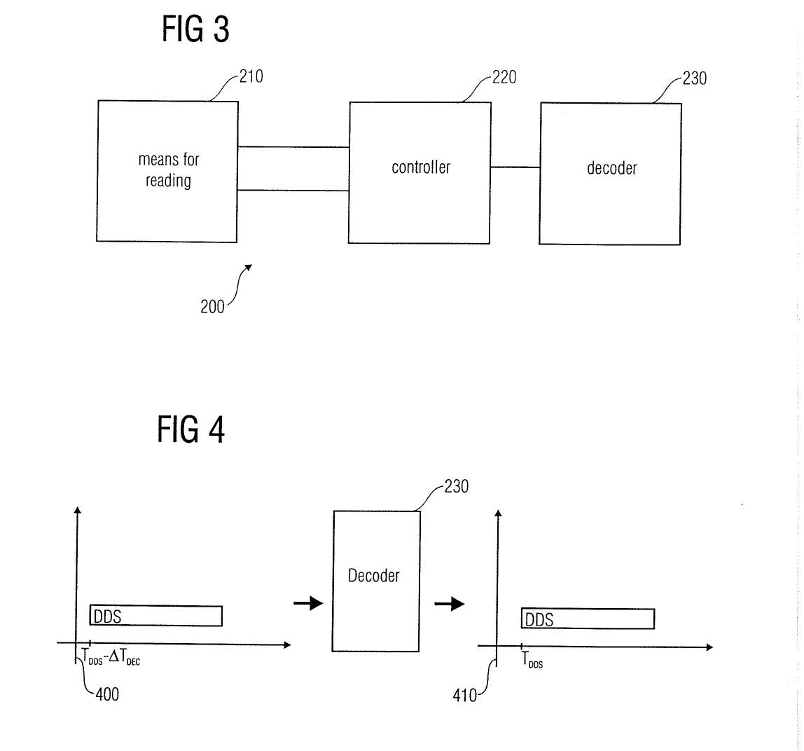

FIG. 3 shows the block diagram of another embodiment of the present invention. Similar compared to FIG. 2, FIG. 3 depicts an embodiment of the inventive apparatus 200 for decoding, comprising a means 210 for reading and a controller 220. Additionally, FIG. 3 shows a decoder 230, which is coupled to the controller 220. As mentioned above, the controller 220 extracts the digital data sets and provides the digital data sets to the decoder 230 for decoding, taken into account the sequence information from the additional packet. From the additional packet and the sequence information the controller 220 can derive, for example, the decoding delays as they were explained earlier.

FIG. 4 illustrates how the controller can prevent decoding delays from happening when, for example, playing-back audio tracks or video tracks. FIG. 4 shows a first diagram 400, which illustrates the digital data set (DDS) provided from the controller 220 to the decoder 230. The controller 220 derived from the sequence information contained in the additional packet, that a coding delay ΔT_{Dec} will occur when the decoder 230 decodes a digital data set. Therefore, the controller 220 can consider the decoding delay and provide the digital data set early. This is shown in the diagram 400 in FIG. 4. After the decoder has decoded the digital data set at its output, the decoded digital data set is available in time as indicated in the diagram 410 in FIG. 4. From the diagram 410 it can be seen that the controller can compensate for the decoding delay ΔT_{Dec} by providing the digital data set to the decoder early. Early provision of the digital data set plus the decoding delay compensate each other so that the decoded data is available at the proper time T_{DDS}.

Another embodiment of the present invention is depicted in FIG. 5. The embodiment depicted in FIG. 5 relates to the case when overlapping digital data sets occur, i.e. decoded data is overlapping in the time domain, and it also covers the case when a decoder has an initialisation period, evoking the coding delay even if two encoded digital data sets are provided right after each other to the same decoder. FIG. 5 shows an embodiment of an inventive apparatus 200 for decoding. The apparatus 200 comprises a means 210 for reading coupled to a controller 220. Similar to the explanation of FIG. 4, the controller is coupled to a decoder 230 for provision of encoded digital data sets. In FIG. 5, the controller 220 is coupled to an additional decoder 235 also for providing encoded digital data sets. By having two decoders 230 and 235 at its disposal, the controller 220 can coordinate even overlapping data sets and compensate for initialisation periods that certain codes employ. In another embodiment of the present invention, the controller 220 further extracts meta-data as the data mentioned above.

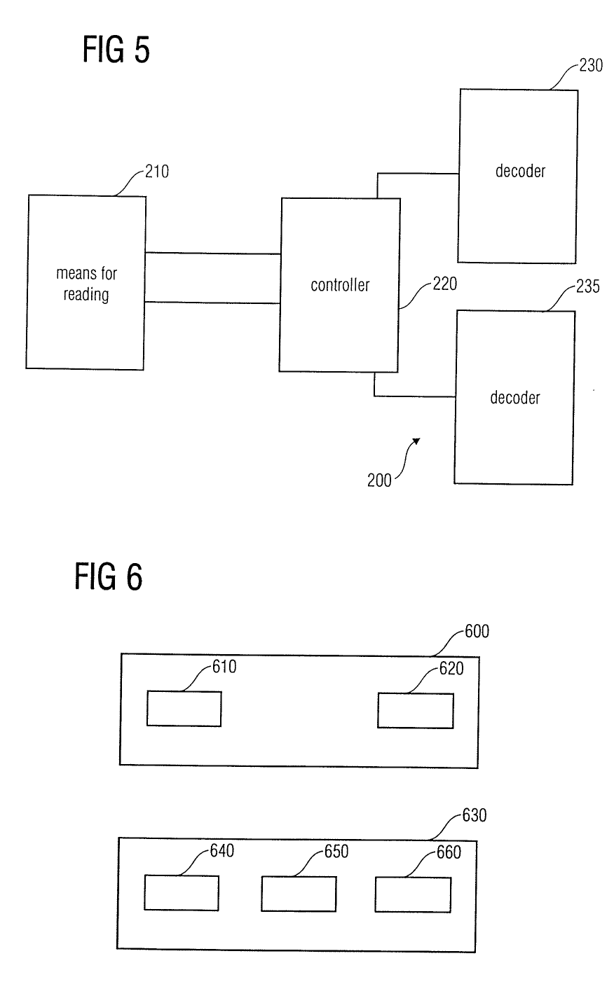

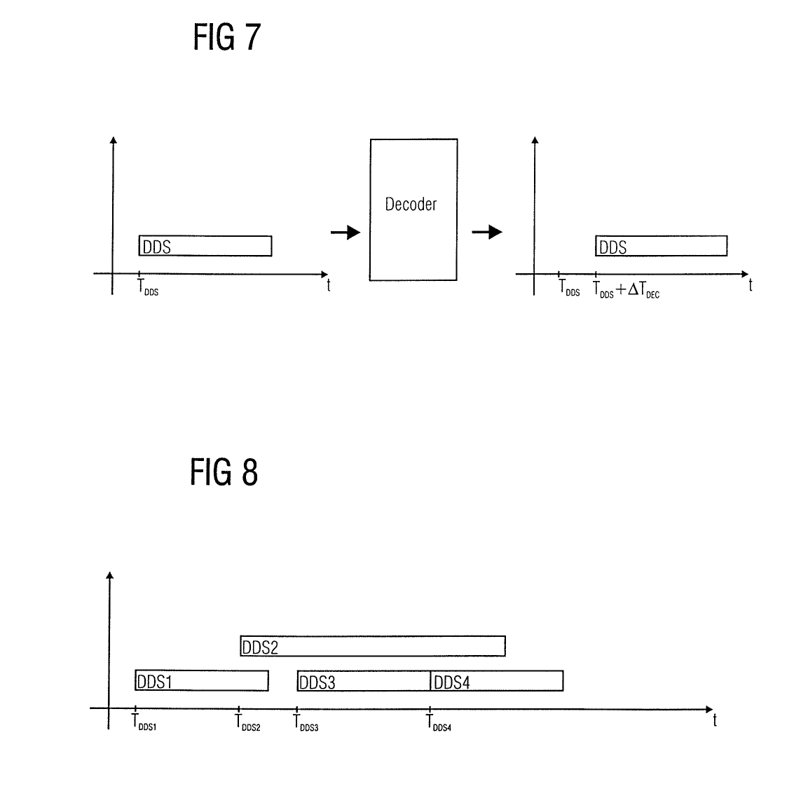

FIG. 6 shows two embodiments of inventive data files. At the top of FIG. 6, an embodiment of a data file 600 is depicted comprising a content packet 610 and an additional packet 620. At the bottom of FIG. 6, another data file 630, comprising a content packet 640, an additional packet 650, and a meta-data packet 660. The meta-data 660 packet contains any meta-data as mentioned above, however, both data files 600 and 630 depicted in FIG. 6 may contain meta-data, however, the data file 600 may have meta-data in the additional packet 620. In one embodiment of the present invention, the data files as depicted in FIG. 6 are used for data storage or transmission.

The meta-data comprises one of or a combination of a group of, for example loudness settings, equalization settings, display settings, playback options, instrumentation, lyrics, title, names, song names, clip information, places of origin, author, group, singer, interpreter, location of recording, genre, cover, booklet, label, or any other meta-data.

One embodiment of the present invention is a novel storage format that could be an extension to the already established stream format such as MPEG-4 systems, ISO-IEC 14496-1 (IEC=International Electrotechnical Community). In this embodiment even the deciding systems have no knowledge about the inventive approach and could still benefit from being able to decode or play-out the stream but with no extra features to be added.

An important advantage of embodiments of the present invention is the additional packet, which describes the exact time information of the original digital data sets, or input tracks, as well as any additional timing offset inside those digital data sets or tracks. The additional packet can be accompanied with optional additional information about the coding system delay so that on the decoder side it is possible to reconstruct the signal without any delay or timing mismatch between the decoded digital data sets and the original, cf. FIG. 4.

Furthermore, an embodiment of the present invention aggregates all input audio tracks in a single, continuous audio stream stored in the target stream, which enables to achieve a maximum compatibility, even if the underlying system such as MPEG-4 systems is capable of storing multiple audio tracks, most of the decoders in a market will not be able to understand multiple tracks stored separately in the MPEG-4 file, for example. Therefore, only the first track would be played-back with the backward compatible device.

Optionally, embodiments of the present invention provide additional information about the audio programs covered in an interval, which can be done for each interval defined, such as meta-data as lyrics, song names, etc. It is also possible to define this data globally, for the all-stored audio video programs, and this would correspond to, for example, album or concert meta-data, such as an album name, author, genre, etc.

Moreover, embodiments of the present invention also store loudness data per audio program or video program, respectively globally, i.e. for the entire collection, for example. This information could be used in a decoding device to equalize the loudness and to prevent any hearing damage that would arise because of sudden loudness changes.

Furthermore, embodiments of the present invention also provide image art work such as covers or booklets, usually found in audio CDs or video DVDs, in bitmap form, so that this data could be either displayed and/or printed on the decoding side of transmission.

The present invention further provides an apparatus and a method of encapsulating multiple audio programs, tracks, or streams in a single, continuous master program and aggregated stream, preserving the exact duration and offsets of the original audio programs even after the optional process of lossy audio compression by methods known in the state-of-the-art. Moreover, the invention creates a method of storing, on storage device, at least one packet of information about the aggregated stream in form of the logical structure defining the time-mapping properties of the optional audio coding apparatus involved in the coding process such as coding system algorithmic delay and time information about the duration of the original (non coded) audio programs that are aggregated in the stream. Alternatively, only the information package necessary for identifying the coding system is stored, so that the decoding device apparatus could deduct the time-mapping properties of the aggregated stream by using information stored in its own memory and related to the said coding system.

Optionally a single or a plurality of packets of information about the aggregated stream can be stored, in form of the logical structure defining the additional time-mapping properties of the audio programs, such as time information about specific events in the aggregated audio streams. Optionally, the logical structure defining the naming of the single or the plurality of aggregated audio streams, the logical structure containing information about the audio signal loudness of the single or plurality of audio programs stored in the aggregated stream or the logical structure containing information about the additional data related to the single or plurality of audio programs stored in the aggregated stream such as Artist, Genre, Tempo, Mood, Lyrics can be stored. Another data that can optionally be stored are the logical structure containing information about additional data related to the single or plurality of audio programs stored in the aggregated stream such as bitmap representation of the artwork associated with the original audio programs.

In another embodiment of the present invention, a method comprises transferring the packets from the storage medium as arranged in the logical structure across the transport medium to a destination computer.

In one embodiment the apparatus for preparing the aggregated stream comprises a means to receive original input audio programs and related meta-data, process them and store them. It can further comprise means to obtain the loudness of single or plurality of audio streams and store them in the aggregated stream. Another embodiment additionally represents an apparatus for parsing and decoding the aggregated stream and to store them. In yet another embodiment the apparatus further comprises a means to restore the original audio program time information, such as length, and eliminate any delays introduced by the coding process by altering the decoded audio signal and using information stored. Optionally it may further comprise a means to alter the loudness of the decoded audio signal by using the information stored.

Depending on certain implementation requirements of the inventive methods, the inventive methods can be implemented in hardware or software. The implementation can be performed using a digital storage medium, and particularly a disc, DVD or a CD having electronically readable control signals stored thereon, which cooperate with the programmable computer system such that the inventive methods are performed. Generally, the present invention is, therefore, a computer program product with a program code stored on a machine-readable carrier, the program code being operative for performing the inventive methods when the computer program product runs on a computer. In other words, the inventive methods are, therefore, a computer program having a program code for performing at least one of the inventive methods, when the computer program runs on a computer.

### REFERENCE LIST

100 Apparatus for encoding
110 Means for aggregating digital data sets
120 Means for aggregating sequence information
130 Output for content packet
140 Output for additional packet
150 Input for original data
200 Apparatus for decoding
210 Means for reading
220 Controller
230 Decoder
235 Second decoder
400 Time diagram coded digital data set
410 Time diagram decoded digital data set
600 Data file
610 Content packet
620 Additional packet
630 Data file
640 Content packet
650 Additional packet
660 Meta-data packet

1. Apparatus for encoding a plurality of digital data sets, a digital data set having a data frame structure, in which a data frame corresponds to a time period, the number of bits per time period being variable, the plurality of digital data sets being ordered in a time sequence, the apparatus comprising:
a means for aggregating the plurality of digital data sets in a content packet; and
a means for aggregating sequence information on the time sequence in an additional packet, the sequence information being such that a rendering relation of two digital data sets can be derived from the sequence information.

2. Apparatus of claim 1, wherein the means for aggregating the sequence information is adapted for including information on an address or on a logical pointer to a starting point of a digital data set within the content packet and the sequence information.

3. Apparatus of claim 1, wherein the means for aggregating the sequence information is adapted for including information on time stamps, timing information, or timing offsets of starting points of digital data sees within the content packet in the sequence information.

4. Apparatus of one of the claims 1 to 3, wherein the means for aggregating the sequence information is adapted for including further information on one of or a combination of the group of a coding type, a coding rate, a coding delay or a code in the sequence information.

5. Apparatus of one of the claims 1 to 4, wherein the apparatus for encoding further comprises a means for aggregating meta-data including further information on one of or a combination of the group of loudness, equalization settings, display settings, or playback options of the digital data sets in an additional packet.

6. Apparatus of claim 5, wherein the means for aggregating meta-data is adapted for including further information on one of or a combination of the group of meta-data, instrumentation, lyrics, title, name, song name, clip information, place of origin, author group, singer, interpreter, location of recording or genre of digital data sets in the meta-data packets.

7. Apparatus of one of the claims 5 or 6, wherein the means for aggregating meta-data is adapted for including further information on one of or a group of a cover, a booklet, or a label of a digital data set in the meta-data packet.

8. Apparatus of one of the claims 1 to 7, wherein the apparatus is further adapted for aggregating the content packet, the additional packet, or the meta-data packet into an aggregated packet for transmission or storage.

9. Apparatus of one of the claims 1 to 8, wherein a digital data set comprises an audio or video track.

10. Apparatus of claim 9, wherein a digital data set is a psycho-acoustically encoded audio track.

11. Apparatus of claim 9 wherein a digital data set is a lossy encoded data packet.

12. Method for encoding a plurality of digital data sets, a digital data set having a data frame structure, in which a data frame corresponds to a time period, the number of bits per time period being variable, the plurality of digital data sets being ordered in a time sequence, comprising the steps of:
aggregating the plurality of digital data sets in a content packet; and
aggregating sequence information on the time sequence in an additional packet, the sequence information being such that the rendering relation of two digital data sets can be derived from the sequence information.

13. Apparatus for decoding a plurality of digital data sets, a digital data set having a data frame structure, in which a data frame corresponds to a time period, the number of bits per time period being variable, the decoded plurality of digital data sets being ordered in a time sequence, from a content packet and an additional packet, the content packet comprising a plurality of digital data sets, the additional packet having sequence information on the time sequence, the sequence information being such that a rendering relation of two digital data sets can be derived from the sequence information, the apparatus comprising:
means for reading the content packet and the additional packet; and
a controller for extracting the plurality of digital data sets on the content packet, for extracting the sequence information from the additional packet, and for ordering the digital data sets based on the sequence information.

14. Apparatus of claim 131 further comprising a decoder for decoding digital data sets, the decoder being coupled to the controller, the controller being adapted for providing digital data sets to the decoder such that the decoded digital data sets are ordered in the time sequence.

15. Apparatus of claim 14, further comprising a second decoder for decoding digital data sets, the second decoder being coupled to the controller, the controller being adapted for providing digital data sets to the second decoder such that the decoded digital data sets from the decoder and the second decoder are ordered in the time sequence.

16. Apparatus of one of the claims 13 to 15, wherein the controller is adapted for extracting information on an address or on a logical pointer to a starting point of a digital data set within the content packet from the sequence information.

17. Apparatus of one of the claims 13 to 16, wherein the controller is adapted for extracting information on a time stamp, timing information or timing offsets of starting points of digital data sets within the content packets from the sequence information.

18. Apparatus of one of the claims 13 to 17, wherein the controller is adapted for extracting one of or a combination of the group of a coding type, a coding rate, a coding delay, or a code from the additional packet.

19. Apparatus of one of the claims 13 to 18, wherein the controller is adapted for extracting further information on one of or a combination of the group of loudness, equalization settings, display settings, playback options, instrumentation, lyrics, title name, song name, clip information, place of origin, author, group, singer, interpreter, location of recording, genre, cover, booklet, label or any meta-data from an additional packet.

20. Apparatus of one of the claims 13 to 19, wherein the controller is adapted for extracting an audio or video track from the content packet.

21. Apparatus of one of the claims 14 to 20, wherein the decoder is adapted for decoding psycho-acoustically encoded digital data sets or lossy encoded digital data sets.

22. Method for decoding a plurality of digital data sets, a digital data set having a data frame structure, in which a data frame corresponds to a time period, the number of bits per time period being variable, the plurality of digital data sets being ordered in a time sequence, from a content packet and an additional packet, the content packet comprising the plurality of digital data sets, the additional packet having sequence information oh the time sequence, the sequence information being such that the rendering relation of two digital data sets can be derived from the sequence information, comprising the steps of:
extracting the plurality of digital data sets from the content packet;
extracting the sequence information from the additional packet; and
ordering the digital data sets based on the sequence information.

23. Data file comprising a content packet and an additional packet, the content packet having information on a plurality of digital data sets, a digital data set having a data frame structure, in which a data frame corresponds to a time period, the number of bits per time period being variable, the additional packet having sequence information on a time sequence of the plurality of digital data sets, the sequence information having information on a rendering relation of two digital data sets.

24. Data file of claim 23, further comprising information on one of or a combination of the group of loudness, equalization settings, display settings, playback options, instrumentation, lyrics, title name, song name, clip information, place of origin, author, group, singer, interpreter, location of recording, genre, cover, booklet, label or any meta-data.

25. Data file of one of the claims 23 or 24, wherein a digital data set comprises psycho-acoustically encoded audio data or lossy encoded data.

26. Data file of one of the claims 23 to 25, wherein a digital data set comprises video data.

27. Computer program having a program code for performing the methods of claim 12 or claim 22 when a program code runs on a computer.
